(19) United States
(12) Patent Application Publication
(10) Pub. No.: US 2007/0049305 A1
(43) Pub. Date: Mar. 1, 2007

(54) Method for adjusting timing of channels in a wireless communications system

(75) Inventors: Rainer Walter Bachl, (US); Francis Dominique, Whippany, NJ (US); Hongwei Kong, Whippany, NJ (US); Walid E. Nabhane, Bedminster, NJ (US)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 11/212,016

(22) Filed: Aug. 25, 2005

(51) Int. Cl. H04B 7/005

(52) U.S. Cl. 455/502

(57) ABSTRACT

A method is provided for adjusting timing of transmissions within a wireless communications system. The method comprises receiving a request for a timing adjustment and adjusting timing of a DPCH in a first frame. The timing of at least one of an E-RGCH and an E-HICH is then adjusted in a second frame associated with the first frame.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of base stations (or NodeBs in 3GPP (3^{rd} Generation Partnership Project) terminology) distributed within an area to be serviced by the system. Various mobile devices (or User Equipment-UE in 3GPP terminology) within the area may then access the system and, thus, other interconnected telecommunications systems, via one or more of the base stations. Typically, a mobile device maintains communications with the system as it passes through an area by communicating with one or more base stations, as the mobile device moves. The process of communicating with multiple base stations simultaneously is commonly referred to as a soft nandoii and it may occur relatively often if the mobile device is moving rapidly. The mobile device may communicate with the closest base station, the base stations with the strongest signal, the base stations with a capacity sufficient to accept communications, etc.

When the mobile device is in soft handoff, multiple base stations are transmitting signals to the mobile device. For design complexity reasons, these signals from different base stations should arrive at the mobile device within a fixed time window. The size of the window directly impacts the mobile device cost, complexity, power consumption, etc. Due to mobility of the mobile device and/or asynchronous base stations, the arrival time of signals from different base stations is constantly changing, and it happens frequently that signals from some base stations fall outside the predefined mobile device receive window (the window position is locked to one base station at a time), resulting in signal losses, poor call quality and sometimes even dropped calls. Therefore a timing adjustment feature is introduced by 3GPP for DPCH (Dedicated Physical Channel) so that the mobile device can signal to the base station to adjust the downlink signal timing backward or forward by a preselected amount to ensure that the cell that is drifting away will be received inside the mobile device reception window. The timing adjustment for the new E-DCH (Enhanced Dedicated Channel) related channels, such as E-HICH (E-DCH HARQ Indicator CHannel) and E-RGCH (E-DCH Relative Grant Channel) are, however, not defined.

### SUMMARY OF THE INVENTION

The present invention is directed to overcoming, or at least reducing, the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to discussed later.

In one aspect of the instant invention, a method is provided for adjusting timing of transmissions within a wireless communications system. The method comprises receiving a request for a timing adjustment and adjusting timing of a first downlink channel in a first frame. The timing adjustment is then applied to a second downlink channel in a second frame associated with the first frame.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system, in accordance with one embodiment of the present invention;

FIG. 2 depicts a block diagram of one embodiment of the downlink communication between a base station and a mobile device in the communications system of FIG. 1;

FIGS. 3 and 5 depict timing diagrams illustrating timing adjustments for channels of the communications system of FIGS. 1 and 2; and

FIGS. 4, 6 and 7 illustrate flowcharts depicting operation of various embodiments of a base station in the communications system of FIGS. 1 and 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

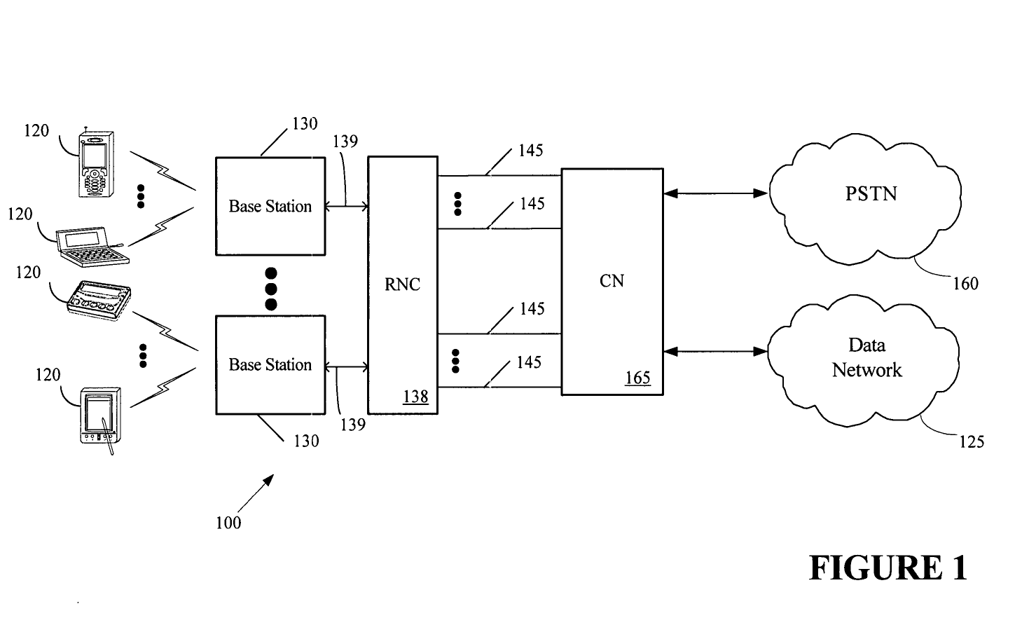

Turning now to the drawings, and specifically referring to FIG. 1, a communications system 100 is illustrated, in accordance with one embodiment of the present invention. For illustrative purposes, the communications system 100 of FIG. 1 is generally compliant with technical specifications and technical reports for a 3^{rd} Generation Mobile System that have been developed by a 3^{rd} Generation Partnership Project (3GPP). Although it should be understood that the present invention may be applicable to other systems that support data and/or voice communications. The communications system 100 allows one or more mobile devices 120 to communicate with a data network 125, such as the Internet, and/or a Publicly Switched Telephone Network (PSTN) 160 through one or more base stations 130. The mobile device 120 may take the form of any of a variety of devices, including cellular phones, personal digital assistants (PDAs), laptop computers, digital pagers, wireless cards, and any other device capable of accessing the data network 125 and/or the PSTN 160 through the base station 130.

In one embodiment, a plurality of the base stations 130 may be coupled to a Radio Network Controller (RNC) 138 by one or more connections 139, such as T1/EI lines or circuits, ATM circuits, cables, optical digital subscriber lines (DSLs), and the like. Although one RNC 138 is illustrated, those skilled in the art will appreciate that a plurality of RNCs 138 may be utilized to interface with a large number of base stations 130. Generally, the RNC 138 operates to control and coordinate the base stations 130 to which it is connected. The RNC 138 of FIG. 1 generally provides replication, communications, runtime, and system management services. The RNC 138, in the illustrated embodiment handles calling processing functions, such as setting and terminating a call path and is capable of determining a data transmission rate on the forward and/or reverse link for each user 120 and for each sector supported by each of the base stations 130.

The RNC 138 is also coupled to a Core Network (CN) 165 via a connection 145, which may take on any of a variety of forms, such as T1/EI lines or circuits, ATM circuits, cables, optical digital subscriber lines (DSLs), and the like. Generally the CN 165 operates as an interface to a data network 125 and/or to the PSTN 160. The CN 165 performs a variety of functions and operations, such as user authentication, however, a detailed description of the structure and operation of the CN 165 is not necessary to an understanding and appreciation of the instant invention. Accordingly, to avoid unnecessarily obfuscating the instant invention, further details of the CN 165 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

Thus, those skilled in the art will appreciate that the communications system 100 facilitates communications between the mobile devices 120 and the data network 125 and/or the PSTN 160. It should be understood, however, that the configuration of the communications system 100 of FIG. 1 is exemplary in nature, and that fewer or additional components may be employed in other embodiments of the communications system 100 without departing from the spirit and scope of the instant invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

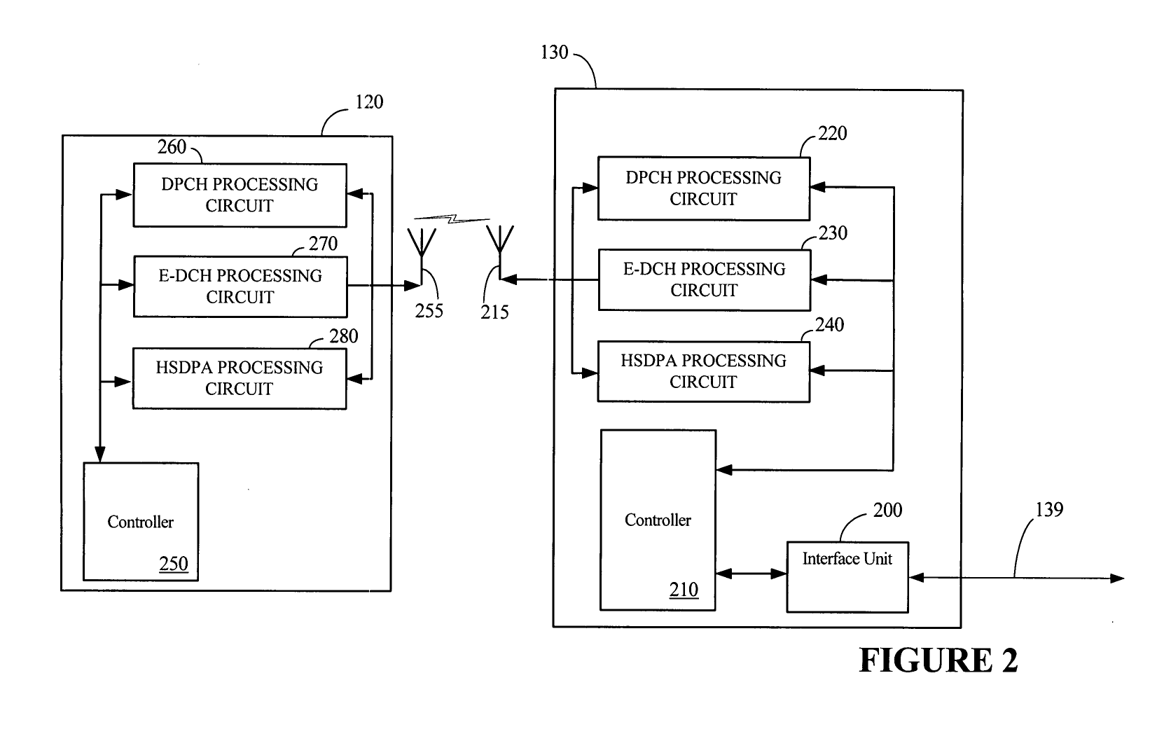

Referring now to FIG. 2, a block diagram of one embodiment of a functional structure associated with an exemplary base station 130 and mobile device 120 is shown for communications from the base station 130 to the mobile device 120, using the Enhanced Dedicated CHannels (E-DCH), such as the E-HICH, E-AGCH and the E-RGCH channels. The base station 130 includes an interface unit 200, a controller 210, an antenna 215 and a plurality of channels, such as a DPCH (Dedicated Physical CHannel), an E-HICH/E-AGCH/E-RGCH (E-DCH HARQ Indicator CHannel/Absolute Grant CHannel/Relative Grant CHannel) and a HS-SCCH/HS-PDSCH (High Speed Shared Control CHannel/Physical Downlink Shared CHannel) along with processing circuitry 220, 230, 240 associated with each of these channels. Those skilled in the art will appreciate that the processing circuitry 220, 230, 240 may be comprised of hardware, software or a combination thereof.

The interface unit 200, in the illustrated embodiment, controls the flow of information between the base station 130 and the RNC 138 (see FIG. 1). The controller 210 generally operates to control both the transmission and reception of data and control signals over the antenna 215 and the plurality of channels between the base station 130 and the mobile device 120, and to communicate at least portions of the received information to the RNC 138 via the interface unit 200. The DPCH processing circuit 220 transmits data and control information to the mobile device 120 over the DPCH channel. In E-DCH applications, the data part in DPCH may be absent but pilot, TFCI (Transport Format Combination Indicator) and TPC (Transmit Power Control) bits are still present and can be used by the mobile device 120 to do tasks such as channel estimation, power control and measurement, channel monitoring, etc. The HS-SCCH/PDSCH processing circuit 240 sends HSDPA (High Speed Downlink Packet Access) control and data information to the mobile device 120 over the HS-SCCH/PDSCH channels, which is processed by the HSDPA processing circuit 280 in the mobile device 120. Typically, the HS-SCCH channel carries control information about the HS-PDSCH channel, such as the block size, retransmission sequence number, etc, while the HS-PDSCH carries the actual packet data for HS-DSCH (High Speed Downlink Shared CHannel). In the mobile device 120, the information derived from HS-SCCH is used by the HS-PDSCH processing circuit 240 to process the data sent by the base station 130 over HSDPA channels. The E-HICH/E-AGCH/E-RECH processing circuit 230 is E-DCH related processing. It sends ACK/NACK information, absolute and relative grants to the mobile device 120 to aid the high speed uplink communications using E-DPCCH and E-DPDCH. The E-HICH/E-AGCH/E-RECH channels are processed by the E-HICH/E-AGCH/E-RECH processing circuit 270 in the UE 120.

The mobile device 120 shares certain functional attributes with the base station 130. For example, the mobile device 120 includes a controller 250, an antenna 255 and a plurality of channels and processing circuitry, such as a DPCH processing circuit 260, an E-HICH/E-AGCH/E-RECH processing circuit 270, a HS-SCCH/PDSCH processing circuit 280, and the like. The controller 250 generally operates to control both the transmission and reception of data and control signals over the antenna 255 and the plurality of channels 260, 270, 280.

Normally, the channels in the mobile device 120 communicate with the corresponding channels in the base station 130. Under the operation of the controllers 210, 250, the channels and their associated processing circuits 220, 260; 230, 270; 240, 280 are used to effect a controlled scheduling for communications from the base station 130 to the mobile device 120.

Typically, operation of the channels and their associated processing circuits 260, 270, 280 in the mobile device 120 and the corresponding channels and processing circuits 220, 230, 240 in the base station 130 have been subframe (2 ms), frame (8 ms) or frame (10 ms) operated.

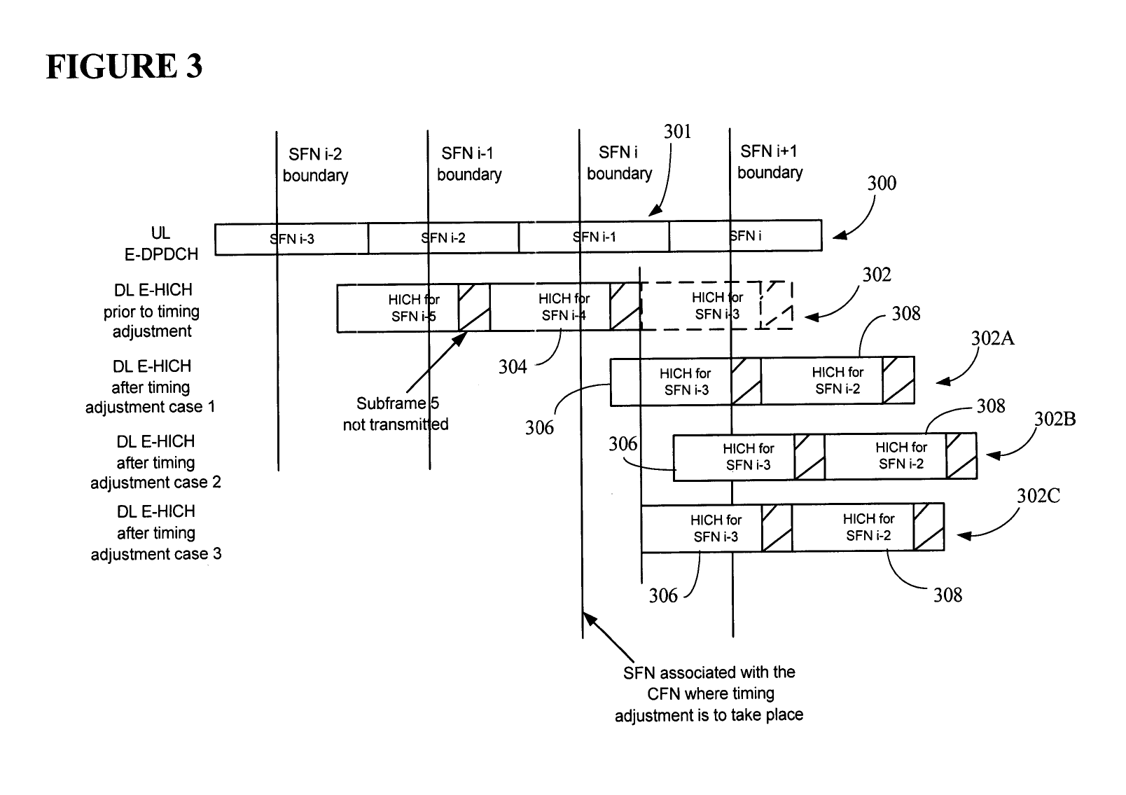

Turning to FIG. 3, a timing diagram illustrating exemplary timing misalignment that may occur within various channels of a 3GPP based system that employs a 10 ms frame is shown. Transmissions within the system are divided into a series of units typically identified by a System Frame Number (SFNᵢ). In one embodiment of the instant invention shown in FIG. 3, the SFN is generally defined by a preselected duration of time, such as 10 ms. Timing for the E-DPDCH 300 for System Frame Numbers (SFN) i-3 through i are shown. Timing adjustments to DL DPCH occur, by definition, within the SFN that includes the SFNi boundary, which in the illustrated embodiment occurs within SFNi 301. The timing adjustment may be useful to account for drift or positional changes of the mobile device 120 within a cell. Accordingly, once the timing of the downlink channel DPCH is adjusted, it is also useful to adjust E-DCH downlink channels, such as E-HICH 302 as well as E-RGCH (not shown). Those skilled in the art will appreciate that there are three basic types of adjustments that may be applied—moving the starting time up (timing advance), as shown in 302A, moving the starting time back (timing delay), as shown in 302B, or making no change, as shown in 302C. For two of the adjustments (i.e., no change and delaying), no issues are created with respect to the previous frame 304 (HICH for SFNi-2) because there is no overlap. Additionally, advancing the timing of the downlink channels does not create an issue despite an apparent overlap between frames 304, 306 (HICH for SFNi-2 and SFNi-3), as shown in 302A. Those skilled in the art will appreciate that the final subframe (e.g., subframe 5) within the frame 304 (HICH for SFNi-4) is empty. Thus, there is no actual overlap of information or data, which allows the frame 306 (HICH for SFNi-3) to be transmitted early without any conflict with the frame 304 (HICH for SFNi-2). Those skilled in the art will appreciate that it may in some embodiments be useful to immediately apply an adjustment to the downlink channels, as shown in the embodiment of FIG. 3; however, in some embodiments of the instant invention it may be useful to make the adjustment to the downlink channel in a subsequent frame, such as the frame 308 (HICH for SFNi-2), or later.

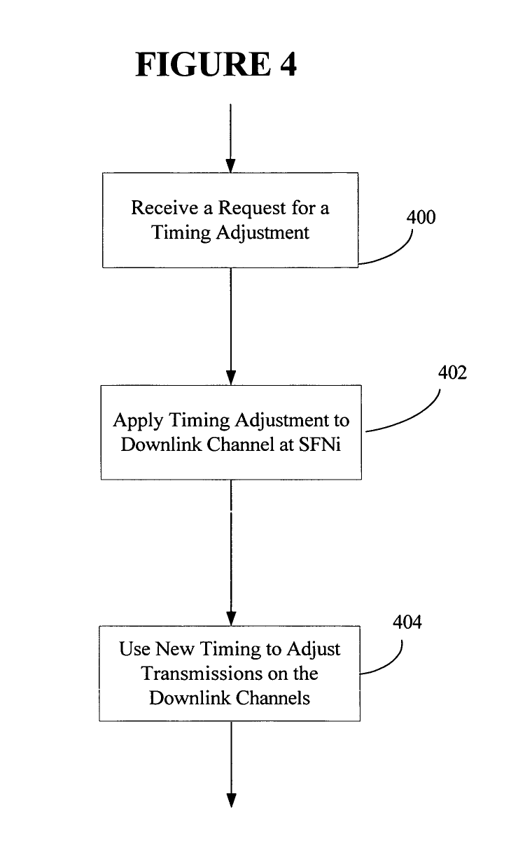

Operation of the instant invention may be appreciated by reference to the flow chart of FIG. 4 and the timing diagram of FIG. 3. The process begins at block 400 with the base station 130 receiving a request from the mobile device 120 to adjust timing. The base station 130 at block 402 applies a timing adjustment to the downlink channel DPCH at the frame 301 (SFNi). At block 404, the base station 130 then uses the adjusted timing to control transmissions on the downlink channels, such as E-HICH 302. As discussed above, the use of the adjusted timing to control transmissions on the downlink channels may begin immediately, such as to deliver the frame 306 (HICH for SFNi-3) or later, such as to deliver the frame 308 (HICH for SFNi-2).

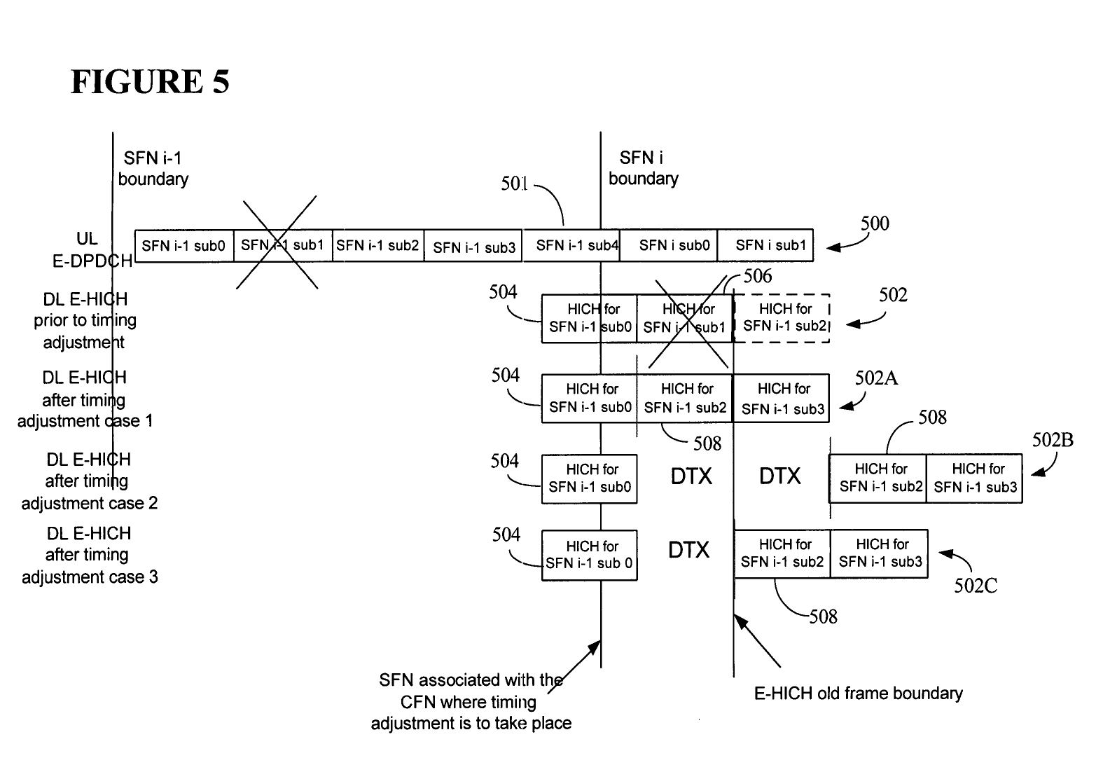

Turning now to FIG. 5, an alternative embodiment of the instant invention is shown where the E-HICH or the E-RGCH channels are defined by a shorter preselected duration of time, such as 2 ms. This embodiment differs principally in that the subframe immediately prior to the timing adjustment is not empty, and thus overlaps can create a conflict.

Transmissions within the system are divided into a series of units typically identified by a System Frame Number (SFNᵢ) and a subframe number (sub). In one embodiment of the instant invention shown in FIG. 5, the SFN is generally defined by a multiple number of subframes, such as 5 where each subframe is 2 ms. Timing for the E-DPDCH 500 for SFNi-1 sub0 through SFNi sub1 are shown. Timing adjustments to DL DPCH occur, by definition, within the frame that starts within the SFNi, which in the illustrated embodiment occurs within SFNi 501. The timing adjustment may be useful to account for drift or positional changes of the mobile device 120 within a cell. Accordingly, once the timing of the downlink channel DPCH is adjusted, it is also needed to adjust downlink channels, such as E-HICH 502 as well as E-RGCH (not shown). Those skilled in the art will appreciate that there are three basic types of adjustments that may be applied—moving the starting time up (timing advance), as shown in 302A, moving the starting time back (timing delay), as shown in 302B, or making no change, as shown in 302C. For two of the adjustments (i.e., no change and delaying), no issues are created with respect to the previous subframe 504 (HICH for SFNi-2 sub 0) because there is no overlap. However, speeding up the timing of the downlink channels does create an issue because of an overlap between subframes 504, 506 (HICH for SFNi-1 sub 0 and SFNi-1 sub 1), as shown in 502A. This overlap issue is overcome by the base station 130 discarding the overlapping subframe 506 (HICH for SFNi-1 sub1), and instead transmitting the next subsequent subframe 508 (HICH for SFNi-1 sub2) as shown at 502A.

In the instance where the timing change causes a delay in transmitting the downlink channels, there are several choices. For example, the base station 130 may accomplish the delay by not transmitting (DTXing) for two subframes and then transmitting the next subframe 508 (HICH for SFNi-1 sub2), as shown at 502B. This can allow the mobile device 120 to have the same behavior without taking into account the adjustment type (timing delay/timing advance/no change), i.e. not transmitting in SFNi-1 subframe 1. Alternatively, may the base station 130 accomplish the delay by not transmitting (DTXing) for 1 subframe and transmitting the previous subframe 506 and the next subframe 508 (HICH for SFNi-1 sub2), (not shown). This can allow the mobile device 120 to transmit all subframes. This allows more data to be transmitted while adding more complexity to the mobile.

In the instance where the timing change causes no change in transmitting the downlink channels, there are at least two possible behaviors. For example, the base station 130 does not transmit (DTXes) only the subframe 506 (HICH for SFNi-1 sub1) and then transmitting the next subframe 508 (HICH for SFNi-1 sub2), as shown at 502C. This can allow the mobile device 120 to have the same behavior without taking into account the adjustment type (timing delay/timing advance/no change), i.e. not transmitting in SFNi-1 subframe 1. The base station 130, as well as, the mobile device 120, transmit all subframes and behave as if no timing adjustment occurred on the DL DPCH channel in SFNi (not shown).

Those skilled in the art will appreciate that it may in some embodiments be useful to immediately apply an adjustment to the downlink channels, as shown in the embodiment of FIG. 5; however, in some embodiments of the instant invention it may be useful to make the adjustment to the downlink channel in a subsequent subframe, such as the subframe 508 (HICH for SFNi-1 sub 2), or later.

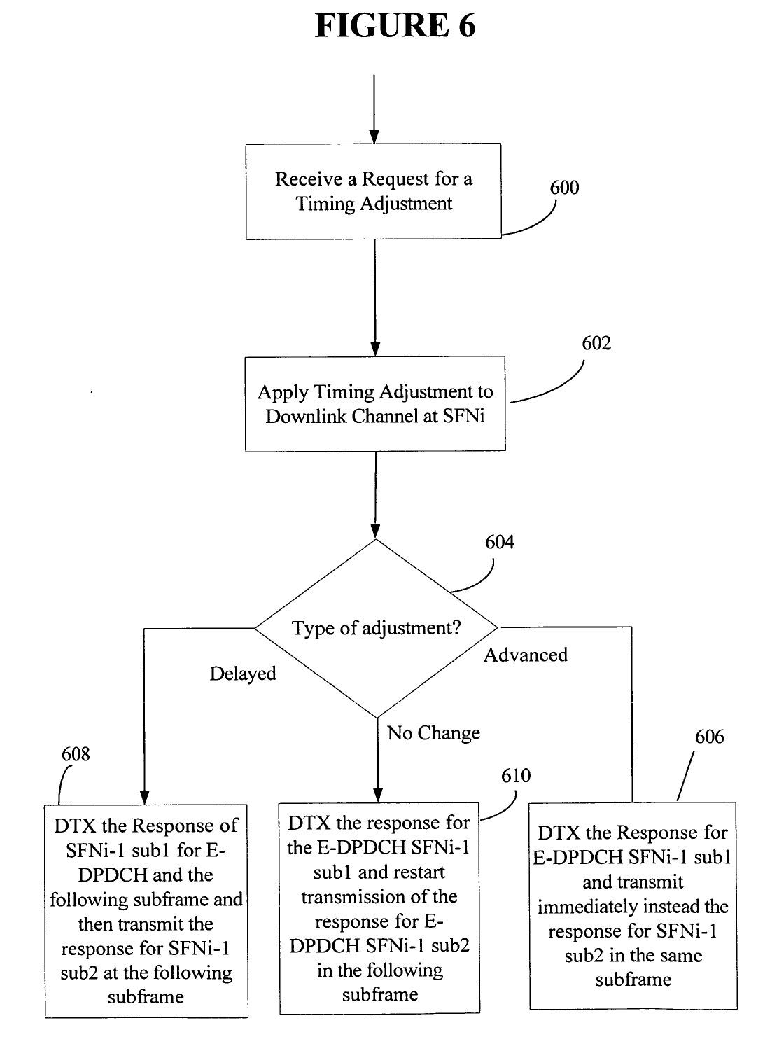

Operation of the instant invention may be appreciated by reference to the flow chart of FIG. 6 and the timing diagram of FIG. 5. The process begins at block 600 with the base station 130 receiving a request from the mobile device 120 to adjust timing. The base station 130 at block 602 applies a timing adjustment to the downlink DPCH at the subframe 500 (SFNi). At block 604, the base station 130 uses the type of adjustment (e.g., timing delay, timing advance, or no change) to take the appropriate action. For example, at block 606 if the timing advance is applied on the downlink DPCH channel, then the base station 130 DTXes the subframe 506 (SFNi-1 sub1) and immediately transmits the next subframe 508 (SFNi-1 sub2). Alternatively, at block 608 if the timing adjustment delays the downlink channels, then the base station 130 DTXes the subframe 506 (SFNi-1 sub 1) waits for an additional subframe and then transmits the next subframe 508 (SFNi-1 sub2). Finally, at block 610 if the timing adjustment causes no change to the timing of the downlink channels, then the base station 130 DTXes the subframe 506 (SFNi-1 sub1) and then transmits the next subframe 508 (SFNi-1 sub2).

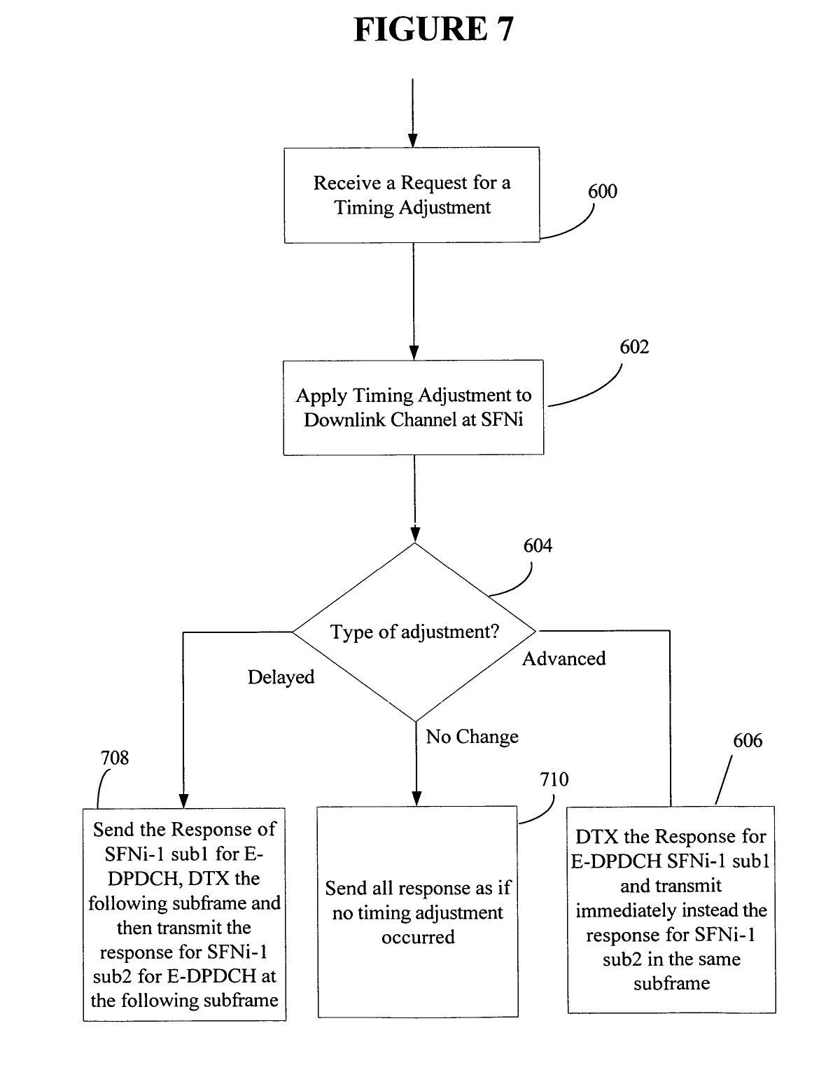

FIG. 7 is a flowchart that illustrates an alternative embodiment of the instant invention. The embodiment of FIG. 7 is substantially similar to that of FIG. 6, differing principally in the actions of the base station 130 when the timing change involves no change or a delay in the timing of the downlink channels. For example, block 710 illustrates the operation of the base station 130 when no change occurs. In this embodiment of the instant invention, all response are sent over the downlink channels as if no timing adjustment occurred. Additionally, block 708 illustrates the operation of the base station 130 if the timing adjustment delays the downlink channels. In this embodiment of the instant invention, the base station 130 sends the subframe 506 (SFNi-1 sub1), DTXes the following subframe and then transmits the next subframe 508 (SFNi-1 sub2) at the following subframe.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), an FPGA, an ASIC (Application Specific Integrated Circuits), a ASSP (Application Specific Standard Product) or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for adjusting the timing of transmissions within a wireless communications system, comprising:
receiving a request for a timing adjustment;
adjusting timing of a first downlink channel in a first frame; and
adjusting timing of a second downlink channel in a second frame associated with the first frame.

2. A method, as set forth in claim 1, wherein adjusting timing of the first downlink channel in the first frame further comprises adjusting the timing of a DPCH.

3. A method, as set forth in claim 2, wherein adjusting timing of the second downlink channel in the second frame associated with the first frame further comprises adjusting timing of at least one of an E-RGCH and an E-HICH in the second frame associated with the first frame.

4. A method, as set forth in claim 3, wherein adjusting the timing of the DPCH further comprises adjusting the timing of the DPCH in a frame associated with SFNi and wherein adjusting timing of the E-HICH in the second frame associated with the first frame further comprises adjusting timing of the E-HICH in a frame associated with SFNi-3.

5. A method, as set forth in claim 3, wherein adjusting the timing of the DPCH further comprises adjusting the timing of the DPCH in a frame associated with SFNi and wherein adjusting timing of the E-RGCH in the second frame associated with the first frame further comprises adjusting timing of the E-RGCH in a frame associated with SFNi.

6. A method, as set forth in claim 1, wherein adjusting timing of the second downlink channel further comprises adjusting the timing of the second downlink channel in steps of 30 symbols.

7. A method, as set forth in claim 3, wherein adjusting the timing of the DPCH further comprises adjusting the timing of the DPCH in a frame associated with SFNi and subframe 0 and wherein adjusting timing of the E-HICH in the second frame associated with the first frame further comprises adjusting timing of the E-HICH in a frame associated with SFNi in subframe 0.

8. A method, as set forth in claim 3, wherein adjusting the timing of the DPCH further comprises adjusting the timing of the DPCH in a frame associated with SFNi and subframe 0 and wherein adjusting timing of the E-RGCH in the second frame associated with the first frame further comprises adjusting timing of the E-RGCH in a frame associated with SFNi in subframe 0.

9. A method, as set forth in claim 1, wherein adjusting timing of the second downlink channel further comprises adjusting the timing of the second downlink channel in steps of subframes.

10. A method for adjusting the timing of transmissions within a wireless communications system, comprising:
receiving a request for a timing adjustment;
adjusting timing of a DPCH in a first frame; and
adjusting timing of at least one of an E-RGCH and an E-HICH in a second frame associated with the first frame.

11. A method, as set forth in claim 10, wherein adjusting the timing of the DPCH further comprises adjusting the timing of the DPCH in a frame associated with SFNi and wherein adjusting timing of the E-HICH in the second frame associated with the first frame further comprises adjusting timing of the E-HICH in a frame associated with SFNi-3.

12. A method, as set forth in claim 10, wherein adjusting the timing of the DPCH further comprises adjusting the timing of the DPCH in a frame associated with SFNi and wherein adjusting timing of the E-RGCH in the second frame associated with the first frame further comprises adjusting timing of the E-RGCH in a frame associated with SFNi.

13. A method, as set forth in claim 10, wherein adjusting timing of at least one of the E-RGCH and the E-HICH further comprises adjusting the timing of at least one of the E-RGCH and the E-HICH in steps of 30 symbols.

14. A method, as set forth in claim 10, wherein adjusting the timing of the DPCH further comprises adjusting the timing of the DPCH in a frame associated with SFNi and subframe 0 and wherein adjusting timing of the E-HICH in the second frame associated with the first frame further comprises adjusting timing of the E-HICH in a frame associated with SFNi in subframe 0.

15. A method, as set forth in claim 10, wherein adjusting the timing of the DPCH further comprises adjusting the timing of the DPCH in a frame associated with SFNi and subframe 0 and wherein adjusting timing of the E-RGCH in the second frame associated with the first frame further comprises adjusting timing of the E-RGCH in a frame associated with SFNi in subframe 0.

16. A method, as set forth in claim 10, wherein adjusting at least one of the E-RGCH and the E-HICH further comprises adjusting the timing of at least one of the E-RGCH and the E-HICH in steps of subframes.
